(19) United States
(12) Patent Application Publication
(10) Pub. No.: US 2011/0074301 A1
(43) Pub. Date: Mar. 31, 2011

(54) Pulse-Width Modulated Signal Generator for Light-Emitting Diode Dimming

(76) Inventor: Dimitry Goder, San Jose, CA (US)

(21) Appl. No.: 12/571,336

(22) Filed: Sep. 30, 2009

(51) Int. Cl. H05B 37/02

(52) U.S. Cl. 315/210

(57) ABSTRACT

A circuit to control light-emitting-diode (LED) dimming of a display panel, is provided. The circuit includes a first stage to receive an incoming PWM signal from an application driver, the incoming PWM signal having a first frequency and a first duty cycle. A second stage in the circuit is provided to produce and transmit an output PWM signal, the second PWM signal having a second frequency according to the characteristics of the display panel, a second duty cycle.

### BACKGROUND

1. Field of the Invention

Embodiments of the present invention relate to light-emitting diode dimming and, in particular, to a pulse-width modulated signal generator for light-emitting diode dimming.

2. Description of Related Art

In current display systems LED dimming is accomplished by using a PWM input as a brightness control. This input signal acts as an ON/OFF control for backlight LEDs. As the duty cycle of the PWM signal changes, so does the time during which LEDs are ON, resulting in adjustable brightness. The brightness of the display is thus independent of the frequency of operation of the LED driving circuit, and is only a function of the duty cycle of the PWM driving signal. The frequency of the PWM signal is usually selected above 100 Hz in order to provide flicker-free operation. However, LCD panel manufacturers often desire operation frequencies much higher than 100 Hz (typically, about 2 kHz) in order to more drastically reduce flicker.

In conventional LED drivers, PWM dimming signals are directly applied to control the driving LED current. In these configurations, the LCD panel has no control over the incoming signal and design engineers need to either specify a limited frequency range of operation of the driving circuit, or perform a thorough evaluation of all possible scenarios so that the LCD panel can be adapted to them. This approach places an inconvenient restriction on the marketability of the LCD panel, or unduly increases its design cost.

Therefore, there is a need to provide for LED dimming that allows for a PWM dimming signal frequency and an LED driving frequency to be different.

### SUMMARY

A circuit to control light-emitting-diode (LED) dimming of a display panel is provided. The circuit includes a first stage to receive a first PWM signal from an application driver, the first PWM signal having a first frequency and a first duty cycle. The circuit is further provided with a second stage to produce and transmit a second PWM signal, the second PWM signal having a second frequency according to the characteristics of the display panel and a second duty cycle related to this first duty cycle.

Some embodiments of the present invention include a backlight system for a Liquid Crystal Display (LCD), including an LCD panel, an LED backlight panel, and a circuit for providing a PWM signal for LED dimming as described above. The circuit provides a PWM signal to a controller circuit that drives the LED panel, and the LED panel thus driven provides light signals to the LCD panel in order to display an image. The circuit receives an incoming PWM signal to drive the LCD panel from an application program that uses video image displays.

More generally, some embodiments of the present invention may include a circuit for processing a first PWM signal in order to produce a second PWM signal with a selected frequency, duty cycle, and synchronization, relative to the first PWM signal or other clock signals provided to the circuit.

These and other embodiments of the present invention are further described with reference to the following figures.

### BRIEF DESCRIPTION OF THE DRAWINGS

FIG. 1 shows a typical system with PWM brightness control for LED-based backlight, according to state-of-the-art techniques.

FIG. 2 shows the temporal profile of a PWM control signal with the resulting LED driving current. Backlight brightness is proportional to the duty cycle of the incoming PWM signal.

FIG. 3 shows a typical LED driver IC, wherein the PWM signal is applied from an external source, according to state-of-the-art techniques.

FIG. 4 shows an embodiment of the present invention, wherein the incoming PWM signal is acquired by a PWM duty cycle acquisition block, replicated at a different frequency by a PWM output generator block, and applied to an LED driver IC.

FIG. 5 shows an embodiment of the present invention wherein the PWM duty cycle acquisition block and the PWM output generator block are part of a TCON circuit providing the control signal for the LED driver IC.

FIG. 6 shows a schematic representation of the operation of the duty cycle measurement circuit as in some embodiments of the present invention.

FIG. 7 shows a schematic representation of the operation of the PWM output generator wherein the output signal has the same duty cycle as the input signal but at a different, programmable frequency, with an additional vertical synchronization step, according to some embodiments of the present invention.

FIG. 8 shows an embodiment of the present invention wherein the PWM duty cycle acquisition block and the PWM output generator block are part of a TCON circuit for multiple purposes.

In the figures, elements having the same designation have the same or similar functions.

### DETAILED DESCRIPTION

The figures and the following description relate to some embodiments of the present invention by way of illustration only. It should be noted that from the following discussion, alternative embodiments of the structures and methods disclosed herein will be readily recognized as viable alternatives that may be employed without departing from the principles of the present invention.

Reference will now be made in detail to several embodiments of the present invention(s), examples of which are illustrated in the accompanying figures. It is noted that, wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

A circuit and a method to control light-emitting-diode (LED) dimming of a display panel using a pulse-width modulation (PWM) scheme are provided. In some embodiments of the present invention, the circuit and method include a first stage to receive a first PWM signal from an application driver, and a second stage to produce and transmit a second PWM signal with a second frequency selected according to the characteristics of the display panel and the first PWM signal, and with a selected synchronization relative to the first PWM signal. Some embodiments of the present invention may also include a clock circuit to measure on-time and off-time intervals of the first PWM signal. The second frequency and the selected synchronization of the signal may be chosen so as to provide synchronization with at least one of a horizontal and a vertical video refresh rate provided by the application driver, eliminating undesirable effects like flickering of the image, which is normally caused by a difference in the frequency between refresh rates of the video image, and the PWM dimming frequency. In some embodiments of the present invention, the second selected frequency is chosen such that a positive edge and a negative edge of the second PWM signal take place during blanking time of the video signal. In this way, undesirable effects like electro-magnetic interference (EMI) can be minimized. Here, blanking time refers to the time when there is no actual video image data transmitted to the LCD. This is sometimes referred to as ‘refresh time’. The incoming video signal comes in frames, usually at a rate of 60 Hz; between two adjacent frames, there is a vertical blanking time. During this time, there is no video signal present, creating a time-gap between two frames. If the PWM signal is synchronized to the vertical blanking time, a consistent dimming scheme is provided for all frames, which may be advantageous according to some embodiments of the present invention.

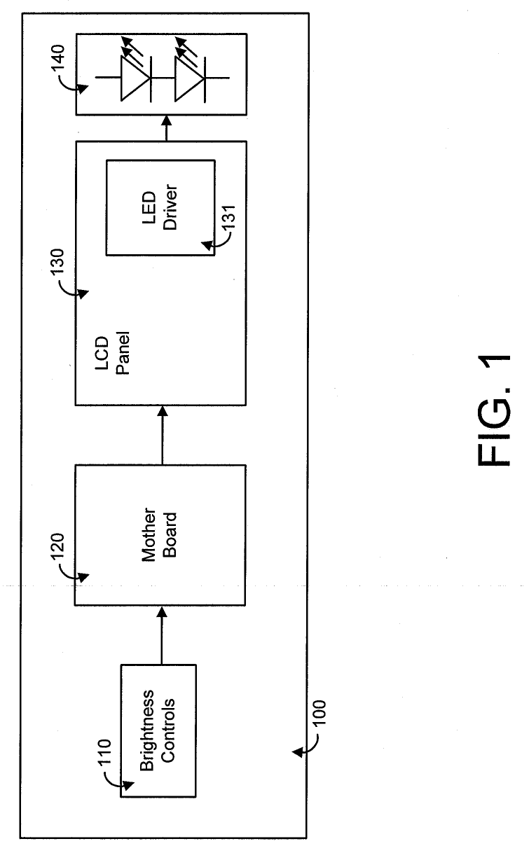

FIG. 1 shows a block diagram for a system 100 with PWM brightness control for an LED backlight system. System 100 may be a display, a Notebook display, a PC monitor, a TV, or some other video device. As shown in FIG. 1, system 100 may include brightness controls 110, a mother board 120, an LCD panel 130, and a display 140. Block 110 includes the brightness controls of the system that determines the brightness level for each pixel in the panel, for a given display frame. Brightness control 110 sends parameters to mother board 120, which generates and terminates a PWM signal to LCD panel 130. LCD panel 130 includes a circuit driver 131 for providing drive current to LEDs in display 140. As can be seen in FIG. 1, the PWM signal in display device 100 is generated by mother board 120, externally to LCD panel 130. This prevents LCD panel 130 from optimizing frequency and synchronization timing of the dimming signal. In particular, the frequency of the signal produced by mother board 120 is usually selected to be above about 100 Hz in order to provide flicker free operation. However, LCD panel manufacturers often desire much higher frequencies of operation, for example in the order of 2 kHz, to reduce flicker even further. Thus, there is often a mismatch between the frequency of the PWM signal produced by mother board 120 and that frequency which is preferred during operation of LCD panel 130.

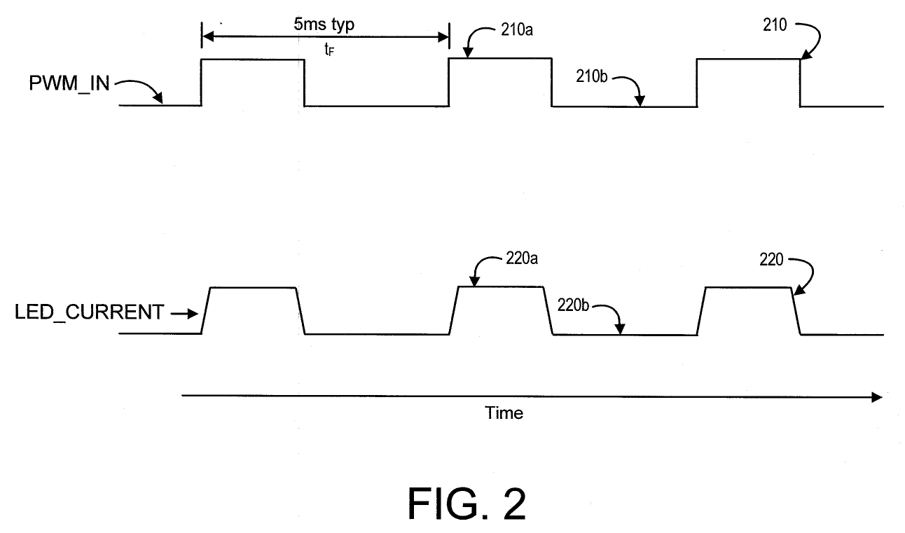

FIG. 2 shows a schematic diagram of the time-profile of an input PWM control signal 210, and the LED drive current 220 generated in response to control signal 210. Control signal 210 includes a “high” signal portion 210a, and a “low” signal portion 210b. High signal portion 210a becomes an LED current portion 220a that turns an LED of display 140 on, and Low signal portion 210b becomes an LED current portion 220b that is essentially zero, or below diode threshold, turning the LED of display 140 off. When the LED is on, it generates a light that illuminates a pixel in LCD panel 130 (FIG. 1). The total amount of time that a given frame will be displayed on the screen during a video streaming event, t_{F}, is the sum of time interval 220a plus time interval 220b. The ratio of the duration of ‘on’ portion 220a to the total frame time, t_{F}, determines the brightness of that particular pixel in that particular frame. This assertion assumes that time t_{F} is well within the resolution time of the human eye (that is, the human eye would not be able to distinguish two events occurring within time interval t_{F}), and also that the response time of the display device (liquid crystal response and lifetimes, voltage turn on/off delays) is much faster than t_{F}. Typically, t_{F} is about 5 ms, which corresponds to a frame rate of about 200 Hz.

Note that, within the validity of the above mentioned assumption, then the brightness of any given pixel in any given frame is mostly determined by the ratio of the duration of portion 220a to t_{F}, and is essentially independent of the frequency of the PWM driving signal. This ratio will be referred to hereinafter as the “duty cycle,” δ. In other words, the brightness of a given pixel in a given frame is dependent on the duty cycle 6 and essentially independent of t_{F}.

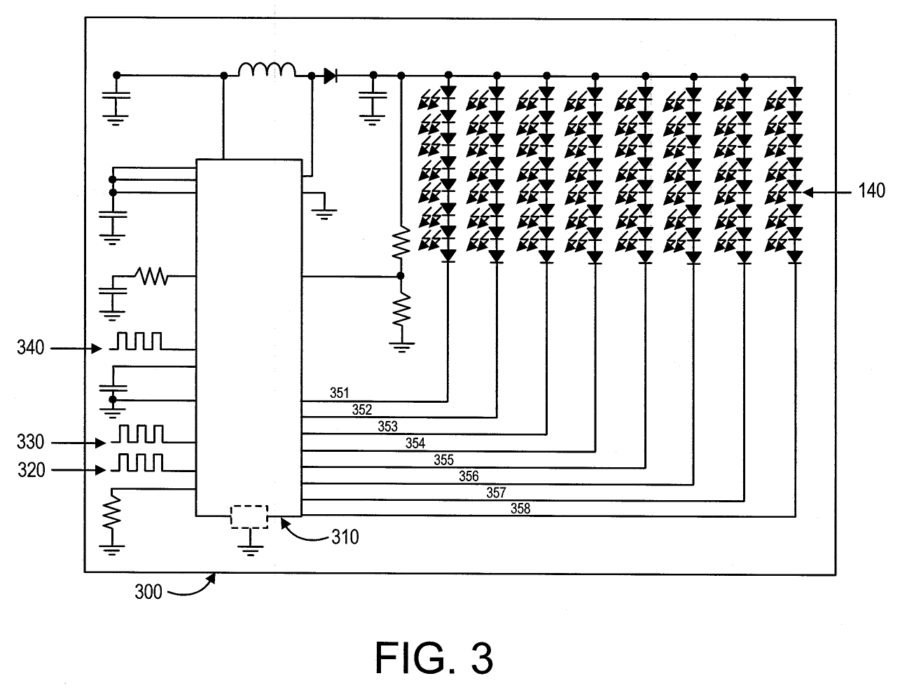

FIG. 3 shows a schematic diagram of a typical example of an LED driver IC 310, which may be, for example, a MAXIM 17061 driver chip, wherein the PWM driving signal 340 is applied to IC 310 from an external source. The external source may be, for example, a cable or antenna coupled to a network broadcasting channel, or it could also be the driver program of certain application software that provides a video interface, e.g. a broad band internet browsing platform, or a computer game application, or any other video display application installed in the memory of the device. A clock signal 330 and a data signal 320 are also provided to LED driver 310, where a specific value of R_{FSET} 300 is provided also, to establish the frequency range of the output PWM control signal.

FIG. 3 also shows LED panel 140, which receives the driving signal from IC 310. Output pins 351-358 in IC 310 provide a forward bias for driving the 8 different columns of LEDs in LED panel 140. According to FIG. 3, the output of IC 310 addresses the columns in the panel separately through each of the terminals 351-358. This takes care of addressing each different pixel in a horizontal scan.

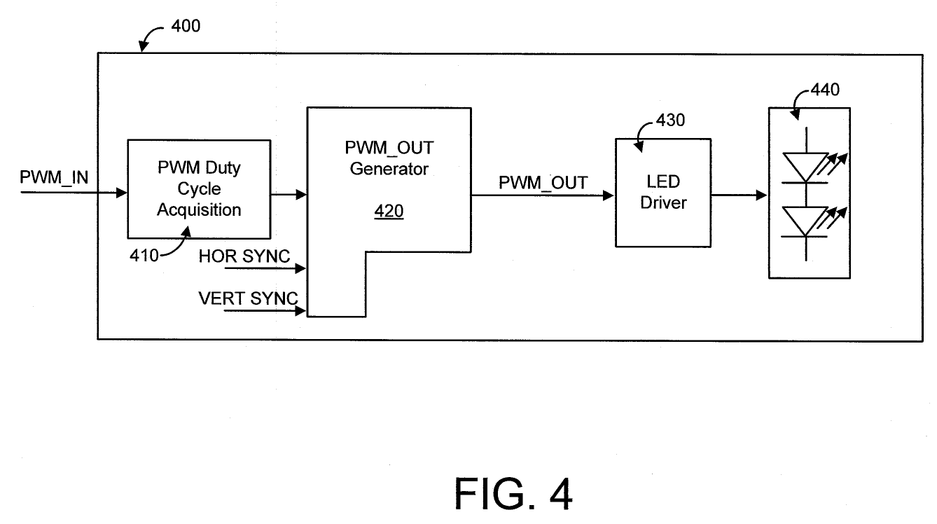

FIG. 4 shows a block diagram of an LED controller circuit 400 according to some embodiments of the present invention. Controller circuit 400 can include a PWM signal acquisition circuit 410, a PWM output generator circuit 420, an LED driver circuit 430, and an LED panel 440. The PWM input signal (PWM_IN) is received from an external source by PWM acquisition circuit 410. The input PWM signal is generated at a first frequency. Circuit 410 then performs an accurate measurement of the duty cycle, δᵢₙ, of the input PWM signal.

The duty cycle acquired in PWM duty cycle acquisition 410 is then transmitted to PWM output generator circuit 420. Here, the speed of the internal clock in PWM duty cycle acquisition 410 is critical for the accuracy of measuring δᵢₙ. According to conventional video applications, t_{F}˜5 ms. Therefore, the speed of the internal clock in 410, according to some embodiments of the present invention is such that an entire clock cycle takes place within a few nano-seconds (ns). Circuit 420 receives the value of δᵢₙ from circuit 410, and generates a PWM output signal at an output frequency that is independent of the first frequency of the input PWM signal. The PWM output signal also has a selected output duty cycle, δₒᵤₜ.

In some embodiments of the present invention, the input and output duty cycles are essentially the same, δₒᵤₜ=δᵢₙ. Further shown in FIG. 4, some embodiments of the present invention may provide a horizontal synchronization signal, or a vertical synchronization signal, or both, to output generator 420, in order to adjust the phase of the PWM output signal (PWM_OUT) appropriately, according to the horizontal and vertical scan of the video signal. This would eliminate the presence of flicker in the image display, which normally occurs when an input signal carrying an image frame overlaps in time with a blanking signal to the LED display. The specific frame is lost, causing the video stream to momentarily lose continuity in the display sequence. Moreover, in the embodiment depicted in FIG. 4, circuit 420 may be capable of adjusting the blanking time of the LED display so that there is no video signal transmitted to the display during this period. This is achieved by providing the PWM output signal from circuit 420 such that both positive and negative edges transition during horizontal blanking time. As further shown in FIG. 4, the LED driver circuit 430 receives the PWM output signal and drives LED panel 440.

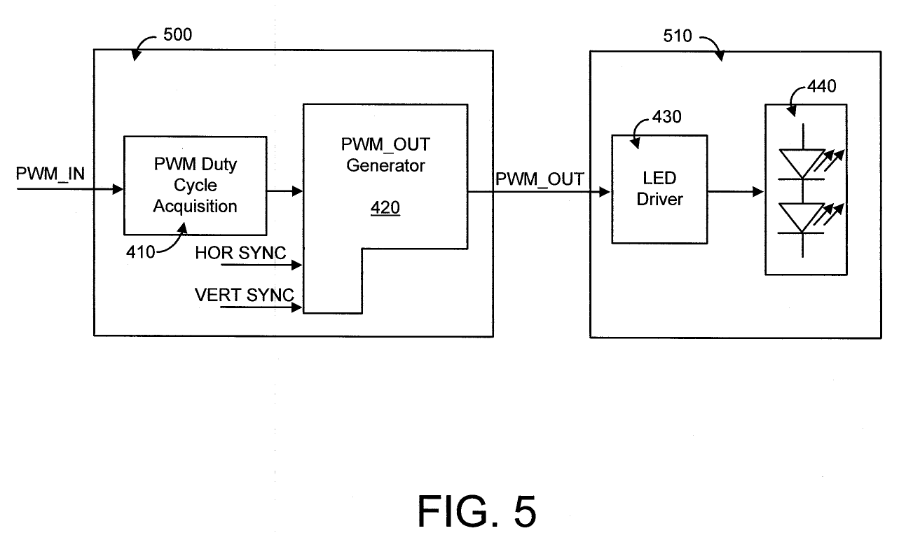

FIG. 5 shows a block diagram of a timing controller circuit 500 (TCON) and an LED controller circuit 510 according to some embodiments of the present invention. Circuit 500 comprises PWM acquisition circuit 410 as described above, and PWM output generator 420, also described in the context of FIG. 4, above. In some embodiments, a horizontal synchronization signal, a vertical synchronization signal, or both, may be provided to PWM output generator 420. The LED controller circuit 510 comprises LED driver circuit 430, and LED panel 440, both circuits 430 and 440 described in the context of FIG. 4, above.

According to the embodiment depicted in FIG. 5, it may be desirable to separate the PWM acquisition circuit 410 and PWM output generator circuit 420, grouped together in TCON circuit 500, from LED driver circuit 510. In this way, TCON circuit 500 may be used in combination with LED controller circuits 510 having different configurations and specifications. Furthermore, the PWM output signal generated by TCON circuit 500 can be used in applications other than video display devices, as can be appreciated by one of ordinary skill in the art of digital signal processing.

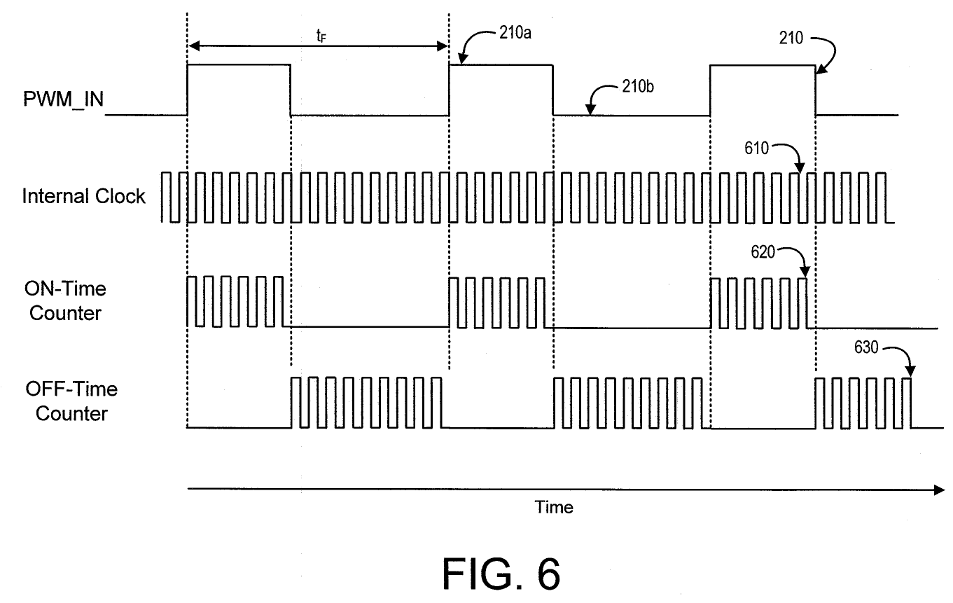

FIG. 6 shows a schematic representation of the method for measurement of the duty cycle of the input PWM signal that may be implemented in PWM acquisition circuit 410 (cf. FIG. 4) according to some embodiments of the present invention. The input PWM signal 210 including a High portion 210a and a Low portion 210b is received by the circuit, and compared to an internal clock signal 610 generated in circuit 410. The total cycle time, t_{F}, is the sum of the time in the High portion 210a and the time in the Low portion 210b. Circuit 410 includes a series of logic gates that provide two output signals based on PWM input signal 210 and clock signal 610. First, an ON-time counter signal 620 is provided, such that it includes only those pulses in the clock signal that overlap a High portion 210a of the PWM input signal. Second, an OFF-time counter signal 630 is provided, such that it contains only those pulses in the clock signal that overlap a Low portion 210b of the PWM input signal. By counting the number of clock pulses contained in signals 620 and 630 and taking the ratio of the count in 620 to the total count of 620 and 630, the input duty cycle, δᵢₙ, is obtained. The accuracy of the ON-time measurement and the OFF-time measurement as described depends on the frequency of clock 610, which can be substantially higher than the frequency of signal 210, according to some embodiments of the present invention. For example, some embodiments of the present invention may use an internal clock operating at 100 MHz (Mega-Hertz), which allows the measurement of ON-time 210a with an accuracy of 10 ns (nano-seconds). A similar result may be obtained for the measurement of OFF-time 210b.

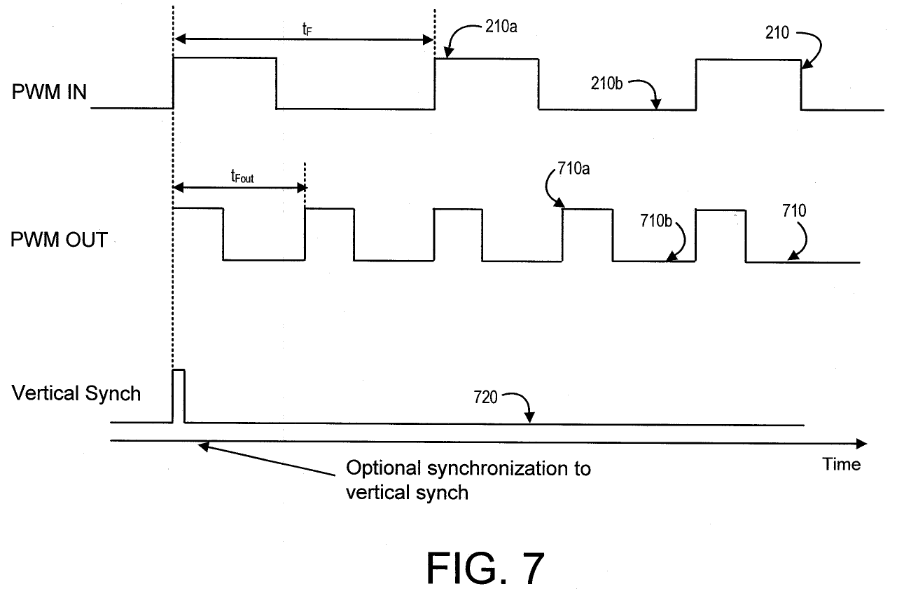

FIG. 7 shows a schematic representation of the method for generating an output PWM signal, implemented in PWM output generator circuit 420 (cf. FIG. 4) according to some embodiments of the present invention. An output signal 710 is generated, having a High portion 710a and a Low portion 710b such that the output duty cycle δₒᵤₜ has a predetermined value. In some embodiments of the present invention, it is desirable to have δₒᵤₜ=δᵢₙ. The time taken for one complete cycle of signal 710, t_{Fout} is a preselected time that can be programmed or transferred into PWM generator circuit 420, and determines the output frequency of the PWM output signal produced by circuit 420.

FIG. 7 shows a schematic representation wherein t_{Fout} is about ½ of t_{F}; however, this scaling is only illustrative. Some embodiments of the present invention may have a value of t_{Fout} that is 10 or 20 times, or more, shorter than t_{F}. One of ordinary skill in the art of signal processing would recognize that reducing t_{Fout} relative to t_{F} by a certain factor is equivalent to increasing the frequency of the PWM output signal relative to the PWM input signal, by the same factor. For example, if t_{Fout} is programmed to be ten times smaller than t_{F}, then for a signal with t_{F}=5 ms, corresponding to a frequency equal to 200 Hz, t_{Fout} would be 0.5 ms, corresponding to a frequency of 2 kHz.

According to some embodiments, a vertical synchronization signal 720 may be used to generate output signal 710 in circuit 420. A selected synchronization relative to the first PWM signal may be obtained. Output signal 710 may be synchronized to an internal signal already present inside an LCD panel. The synchronization can be achieved both in frequency and in phase, according to some embodiments of the present invention. For example, in the embodiment depicted in FIG. 7, the positive edge of the output signal 710 is made to coincide with the positive edge of synchronization signal 720. Some embodiments may use an opposite phase relation, matching the positive edge of signal 710 to the negative edge of signal 720. Moreover, some embodiments may implement any preselected time delay between the positive edge of signal 710 and the positive edge of signal 720. By adjusting and selecting the synchronization of output signal 710, interference artifacts from the PWM dimming action are reduced, and also the noise level present in the LCD panel is suppressed, according to some embodiments of the present invention.

One of regular skill in the art of digital signal processing and video signal processing will recognize that signal 720 may be any type of synchronization signal, including vertical scan synchronization, horizontal scan synchronization, or any combination of the two.

Furthermore, it will be recognized that the synchronization signal may not be limited to a video display configuration, but any other application wherein a PWM signal with a preselected duty cycle and a preselected frequency is desired.

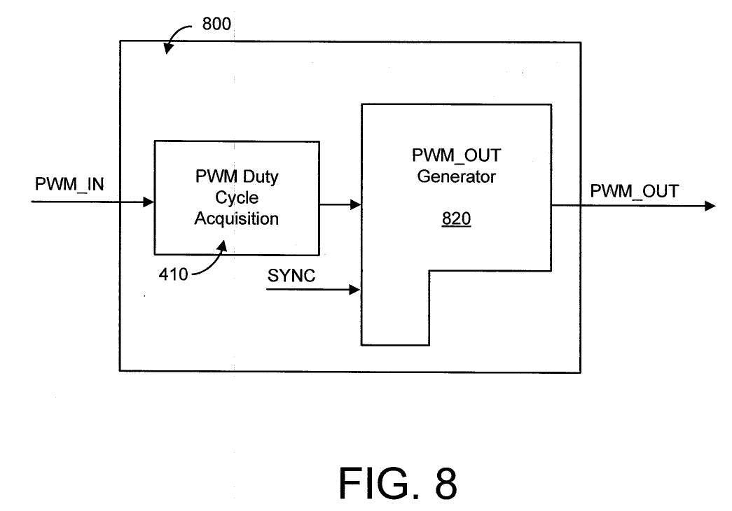

FIG. 8 shows a TCON circuit 800 similar to circuit 500 depicted in FIG. 5, according to some embodiments of the present invention, in which a PWM signal is provided as an input, and a PWM signal is generated as an output. The PWM input signal, which is acquired and measured by circuit 410, may be used for any purpose or application including but not limited to video data stream. The PWM output signal, generated by circuit 820, may also be used for any other purpose or application, including a different application from that of the PWM input signal, further including but not limited to video data stream. The PWM output signal generator circuit according to embodiments as depicted in FIG. 8 operates in substantially the same fashion as circuit 420 (cf. FIGS. 5 and 7), including the use of an input synchronization signal to adjust the phase of the PWM output signal according to some desired value.

Embodiments shown and discussed herein are exemplary only. One skilled in the art may recognize variations that are intended to be within the scope of this disclosure. As such, the invention is limited only by the following claims.

What is claimed is:

1. A circuit to control light-emitting-diode (LED) dimming of a display panel, comprising:
a first stage to receive a first PWM signal from an application driver, the first PWM signal having a first frequency and a first duty cycle;
a second stage to produce and transmit a second PWM signal, the second PWM signal having a second frequency according to the characteristics of the display panel and a second duty cycle according to the first duty cycle.

2. A circuit as in claim 1 above, wherein the first stage further comprises a clock and logic gates to measure on-time and off-time intervals of said first PWM signal.

3. A circuit as in claim 1 above, wherein the second PWM signal is provided a selected synchronization relative to the first PWM signal.

4. A circuit as in claim 1 above, wherein the second frequency and the selected synchronization are chosen so as to provide synchronization with at least one of a horizontal and a vertical video refresh rate provided by the application driver.

5. A circuit as in claim 1 above, wherein the second selected frequency is chosen such that a positive edge and a negative edge of said second PWM signal take place during blanking time.

6. A backlight system for a Liquid Crystal Display (LCD) comprising:
an LCD panel comprising a two dimensional array of pixels;
an LED panel unit comprising a two-dimensional array with at least one LED unit per pixel;
a driving circuit for providing a PWM signal for LED dimming, the circuit further comprising:
a first stage to receive and measure the duty cycle of a first PWM signal, the first PWM signal operating at a first frequency;
a second stage to produce and transmit a second PWM signal with a second selected duty cycle, at a second selected frequency, and with a selected synchronization;
the first stage further comprising a clock to measure on-time and off-time intervals of the first PWM signal;
an LED controller circuit to receive a PWM signal from the driving circuit, and to provide a signal to the LED panel.

7. A circuit for processing pulse-width-modulated (PWM) signals, comprising:
a first stage to receive and measure the duty cycle of a first PWM signal, the first PWM signal operating at a first frequency;
a second stage to produce and transmit a second PWM signal with a second selected duty cycle, at a second selected frequency and with a selected synchronization;
the first stage further comprising a clock and logic gates to measure on-time and off-time intervals of the first PWM signal.

8. A circuit as in claim 7 above, further wherein
a synchronization signal is externally provided to the second stage of the circuit; and
the second stage produces the second PWM signal with a preselected phase-shift, relative to the synchronization signal externally provided.

9. A method to control light-emitting-diode (LED) dimming by using pulse-width-modulated (PWM) signals, comprising:
receiving a first PWM signal having a first frequency;
measuring the duty cycle of the first PWM signal;
providing a second PWM signal at a second frequency with a second selected duty cycle.

10. The method of claim 9, wherein providing a second PWM signal further comprises:
providing a PWM signal with a selected synchronization;
using a clock to measure on-time and off-time intervals of the first PWM signal for the measuring of the duty cycle of a first PWM signal; and
transmitting the second PWM signal to an LED driver circuit.

11. The method of claim 9 wherein using a clock to measure on-time and off-time intervals of the first PWM signal for the measuring of the duty cycle of a first PWM signal further comprises:
using an internal clock signal comprising a sequence of pulses occurring substantially faster than the first PWM signal, said first PWM signal having High portions and Low portions;
using a series of logic gates to compare the first PWM signal to the internal clock signal;
providing a first sequence of pulses corresponding to the internal clock pulses overlapping in time with the High portions of the first PWM signal;
providing a second sequence of pulses corresponding to the internal clock pulses overlapping in time with the Low portions of the first PWM signal;
counting the number of pulses in the first sequence of pulses and in the second sequence of pulses;
finding the duty cycle as the ratio between the number of pulses in the first sequence of pulses to the total number of pulses in the internal clock signal.
